(19) United States
(12) Patent Application Publication
(10) Pub. No.: US 2007/0285836 A1
(43) Pub. Date: Dec. 13, 2007

(54) Magnetic head and method of producing the same

(75) Inventors: Ryuei Ono, Kawasaki (JP); Takashi Ito, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/542,740

(22) Filed: Oct. 4, 2006

(30) Foreign Application Priority Data
Jun. 9, 2006 (JP) 2006-160760

(51) Int. Cl. G11B 5/147; G11B 5/127

(52) U.S. Cl. 360/126; 29/603.01

(57) ABSTRACT

The method is capable of producing a compact magnetic head, which has superior characteristics with a small size recording coil and which is capable of restraining magnetic loss. The magnetic head includes a recording coil, a lower magnetic pole and a back gap section. The method comprises the steps of: forming a seed layer for plating on a lower layer; forming the recording coil on the seed layer, by electrolytic plating, with using the seed layer as an electric power feeding layer; patterning resist on the seed layer so as to form the lower magnetic pole and the back gap section; removing exposed parts of the seed layer; exposing parts of the lower layer, in which the lower magnetic pole and the back gap section will be formed; and forming the lower magnetic pole and the back gap section in the lower layer, by electrolytic plating.

### BACKGROUND OF THE INVENTION

The present invention relates to a magnetic head and a method of producing the magnetic head, more precisely relates to a magnetic head, which is characterized by a unique structure of a write-head, and a method of producing the magnetic head.

In FIG. 4, a structure of a read-head 8 and a write-head 10 of a conventional magnetic head of a magnetic disk drive unit is shown. In the read-head 8, an MR element 5 is sandwiched between a lower shield layer 6 and an upper shield layer 7; in the write-head 10, a write-gap 11 is sandwiched between a lower magnetic pole 12 and an upper magnetic pole 13.

The write-head 10 includes: an upper magnetic pole 13; a lower magnetic pole layer 16; a back gap section 16 connecting the upper magnetic pole 13 and the lower magnetic pole layer 16; and recording coils 14 being wound around the back gap section 15. A magnetic path, which generates a magnetic field in a write-gap 11, is constituted by a lower magnetic pole 12, the lower magnetic pole layer 16, the back gap section 15 and the upper magnetic pole 13. In the magnetic head shown in FIG. 4, two coils 14 are layered.

FIGS. 3A-3F show a conventional process of forming the recording coil 14 and the magnetic poles, which are included in the write-head 10 of the magnetic head.

In FIG. 3A, insulating layers 18 are formed on the lower magnetic pole layer 16, and the coil 14 is formed on the insulating layers 18, so that the coil 14 is electrically insulated from the lower magnetic pole layer 16. The insulating layers 18 are made of alumina or SiO₂. A copper seed layer 20, which is used for electrolytic plating as a power feeding layer, is formed on a substrate, on which the insulating layers 18 have been formed. A resist pattern, which includes grooved parts corresponding to the coil 14, is formed on a surface of the seed layer 20, then the coil 14 is formed by electrolytic plating with using the seed layer 20 as the power feeding layer. In FIG. 3A, the resist has been removed after performing the copper plating.

Since the seed layer 20 entirely coats a surface of the substrate, the substrate is ion-milled so as to remove the exposed parts of the seed layer 20, so that electric short of the coil 14 can be prevented.

In FIG. 3B, the seed layer 20 has been removed by ion milling. The seed layer 20 other than parts under the coil 14 is removed from the surface of the substrate. When the seed layer 20 is removed by ion milling, the seed layer 20 is broken and scattered. Therefore, dusts 20a of the seed layer 20 stick onto side faces of the coil 14.

In FIG. 3C, another seed layer 22, which is used for electrolytic plating as a power feed layer, is formed so as to form the lower magnetic pole 12 and the back gap section 15 of the write-head by plating. Since the lower magnetic pole 12 and the back gap section 15 are made of a material including NiFe, the seed layer 22 is also made of a material including NiFe. The seed layer 22 is formed by sputtering or vapor deposition.

In FIG. 3D, resist 24 is applied on the surface of the substrate and patterned so as to form the lower magnetic pole 12 and the back gap section 15 into prescribed patterns. The coil 14 is coated with the resist 24, and the seed layer 22 is exposed in inner bottom faces of concave parts of the resist 24, in which the lower magnetic pole 12 and the back gap section 15 will be formed.

In FIG. 3E, the lower magnetic pole 12 and the back gap section 15, which are made of the material including NiFe, are formed by electrolytic plating with using the seed layer 22 as the power feeding layer. In case of forming the two-layered coils 14 as shown in FIG. 4, two of the lower magnetic poles 12 and two of the back gap sections 15 are also layered. A state of forming first layers of the lower magnetic pole 12 and the back gap section 15 is shown in FIG. 3E.

After forming the lower magnetic pole 12 and the back gap section 15, the substrate is ion-milled so as to form independent patterns of the coil 14, the lower magnetic pole 12 and the back gap section 15 as shown in FIG. 3F. In FIG. 3F, when the seed layer 22 is removed from the surface of the substrate by ion milling, the seed layer 22 is broken and scattered. Therefore, a magnetic material of the seed layer 20 stick onto side faces of the lower magnetic pole 12, the coil 14 and the back gap section 15.

In case of forming the recording coil and the magnetic poles, which constitute the write-head of the magnetic head, by plating, the seed layers are formed on the substrate as power feeding layers. Therefore, unnecessary parts of the seed layers must be removed after forming electric conductive layers and magnetic layers so as to prevent electric short.

In case of removing the unnecessary parts of the seed layers by ion milling, materials of the seed layers are scattered and stick onto side faces of the coil and electrodes, so that characteristics of the magnetic head will be badly influenced.

In the above described production process of the magnetic head, the dusts 20a of the copper seed layer 20 and the magnetic material 22a of the seed layer 22 stick onto the side faces of the coil 14, etc.

If the unnecessary substances 20a and 22a stick onto the coil 14 and the lower magnetic pole 12, spaces between the coil 14, the magnetic pole 12, etc. are made narrower. Therefore, the coil 14 cannot be made smaller, and the write-head cannot be made smaller. Further, a length of the magnetic path of the write-head cannot be made longer, so that magnetic loss must be occurred.

If the coil 14 can be made smaller, inductance of the coil 14 can be reduced and high-frequency properties of elements can be improved. By restraining to downsize the coil 14, high-frequency properties of the elements cannot be improved.

The seed layer 22, which is used for forming the lower magnetic pole 12 and the back gap section 15 by plating, is provided between in a border part between the lower magnetic pole layer 16 and the lower magnetic pole 12 and a border part between the lower magnetic pole layer 16 and the back gap section 15. The seed layer 22 is made of the magnetic material as well as the magnetic poles. However, the different metal layer 22 is provided under the lower magnetic pole 12 and the back gap section 15, so that magnetic loss occurs in the write-head 10.

### Patent Document 1 Japanese Patent Gazette No. 2002-203303

### Patent Document 2 Japanese Patent Gazette No. 11-175915

### SUMMARY OF THE INVENTION

The present invention was conceived to solve the above described problems, which occur when a recording coil and magnetic poles are formed by electrolytic plating.

An object of the present invention is to provide a compact magnetic head, which has superior characteristics with a small size recording coil and which is capable of restraining magnetic loss.

Another object is to provide a method of producing the magnetic head.

To achieve the objects, the present invention has following structures.

Namely, the method of producing a magnetic head, which includes a recording coil, a lower magnetic pole and a back gap section formed by electrolytic plating, comprises the steps of: forming a seed layer for plating on a lower layer so as to form the recording coil; forming the recording coil on the seed layer, by electrolytic plating, with using the seed layer as an electric power feeding layer; patterning resist on the seed layer so as to form the lower magnetic pole and the back gap section; removing exposed parts of the seed layer with using the resist as a mask; exposing parts of the lower layer, in which the lower magnetic pole and the back gap section will be formed; and forming the lower magnetic pole and the back gap section in the lower layer, by electrolytic plating, with using the seed layer as the electric power feeding layer.

In the method, the resist may be applied to a part of the seed layer, which coats the lower layer and which can be electrically connected to electrodes of a plating apparatus, in the patterning step. In this case, the lower layer can be securely electrically connected to the electrodes of the plating apparatus via the seed layer.

The method may further comprise the steps of: removing the resist after forming the lower magnetic pole and the back gap section; and removing a useless part of the seed layer by ion milling. In this case, the coil can be easily formed as an independent pattern.

In the method, the lower layer may be a lower magnetic pole layer of a write-head, and the recording coil, the lower magnetic pole and the back gap section may be formed on the lower magnetic pole layer.

The magnetic head of the present invention comprises: a write-head including a lower magnetic pole layer, which is formed by electrolytic plating, and a lower magnetic pole and a back gap section, which are formed on the lower magnetic pole layer, and the lower magnetic pole layer and the lower magnetic pole are integrated, and the lower magnetic pole layer and the back gap section are integrated without forming seed layers for plating between the lower magnetic pole layer and the lower magnetic pole and between the lower magnetic pole layer and the back gap section.

Another magnetic head comprises: a write-head including a plurality of lower magnetic poles and a plurality of back gap sections, which are formed by electrolytic plating and layered in a thickness direction, and the lower magnetic poles are integrated, and the back gap sections are integrated without forming seed layers for plating between the lower magnetic poles and between the back gap sections.

By employing the method of the present invention, the seed layer is used for not only forming the recording coil but also the lower magnetic pole and the back gap section by electrolytic plating, so that the process of producing the magnetic head can be simplified. The lower magnetic pole and the back gap section can be integrated with the lower layer without a seed layer, so that magnetic loss can be restrained and characteristics of the magnetic head can be improved. Since the recording coil can be made smaller, the magnetic head can be downsized and its high-frequency properties can be improved. Further, magnetic members forming the magnetic path of the write-head is integrated in the magnetic head, so that magnetic loss can be restrained and characteristics of the magnetic head can be improved.

### BRIEF DESCRIPTION OF THE DRAWINGS

Embodiments of the present invention will now be described by way of examples and with reference to the accompanying drawings, in which:

FIGS. 1A-1F are explanation views showing steps of producing a magnetic head of the present invention;

FIGS. 2A-2C are explanation views showing further steps of producing the magnetic head of the present invention;

FIGS. 3A-3F are explanation views showing the steps of producing the conventional magnetic head; and

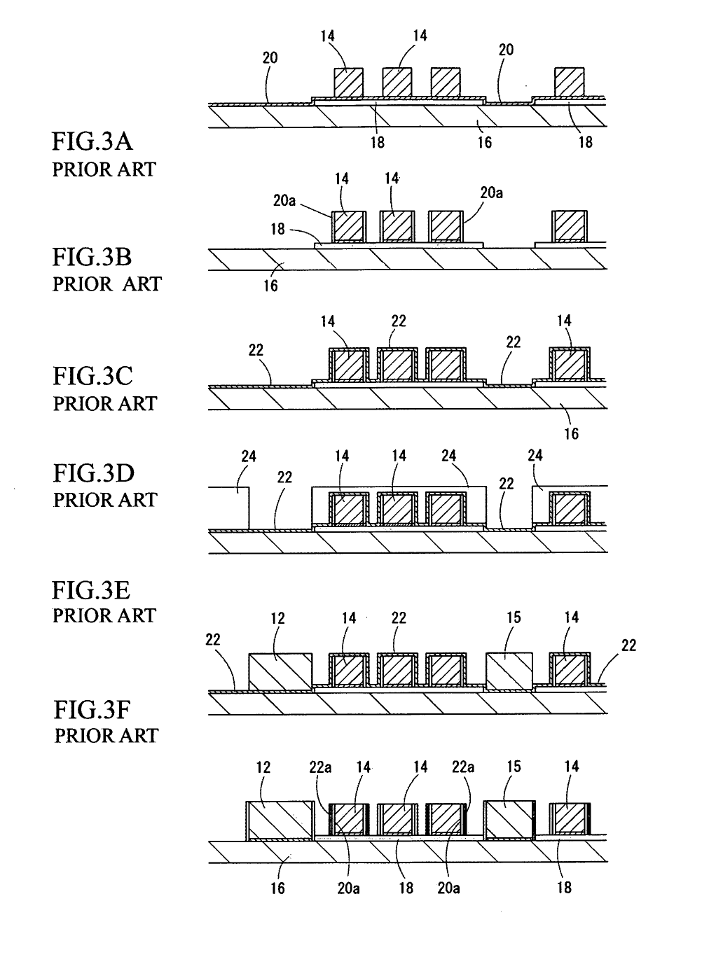

FIG. 4 is a sectional view of the conventional magnetic head.

### DETAILED DESCRIPTION OF THE EMBODIMENTS

Preferred embodiments of the present invention will now be described in detail with reference to the accompanying drawings.

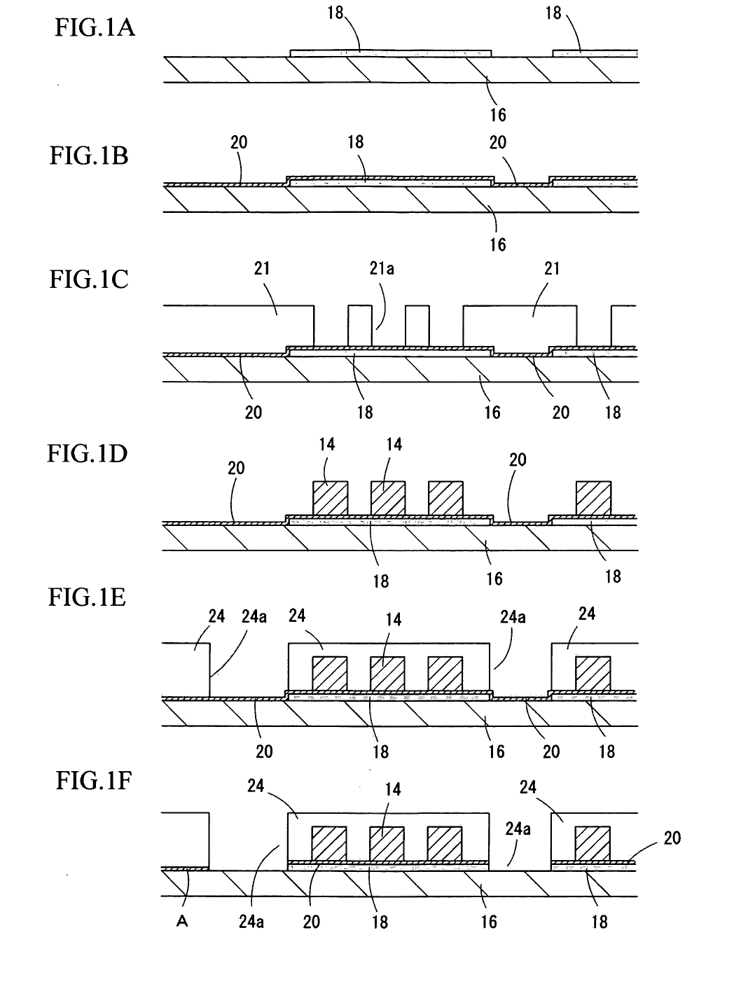

FIGS. 1A-1F are explanation views showing steps of producing a magnetic head of the present invention. The method of the present invention is characterized by the steps of forming a recording coil, a lower magnetic pole and a back gap section of a write-head of the magnetic head. The unique steps will be explained.

In FIG. 1A, a lower magnetic pole layer 16 of a write-head is formed on a substrate, then insulating layers 18, which electrically insulate a recording coil 14 from the lower magnetic pole layer 16. The insulating layers 18, which is made of alumina or SiO₂, is formed by sputtering.

In FIG. 1B, a copper seed layer 20, which acts as a power feeding layer for electrolytic plating, is formed on an entire surface of the substrate, on which the insulating layers 18 have been formed, so as to form the coil 14 by electrolytic plating.

In FIG. 1C, resist 21 is applied on the surface of the substrate, on which the seed layer 20 has been formed, and the resist 21 is optically exposed and developed so as to form a resist pattern 21, which corresponds to a planar pattern of the coil 14. A groove 21a, in which the seed layer 20 is exposed as an inner bottom face and in which the coil 14 will be formed, is formed in an area coated with the resist 21.

In FIG. 1D, electrolytic plating is performed with using the seed layer 20 as a power feeding layer so as to fill the groove 21a with copper, so that the coil 14 is formed. In the drawing, the resist 21 has been removed.

In the conventional method, after forming the coil 14, parts of the seed layer 20 exposed in the surface of the substrate is removed by ion milling so as to prevent short circuit of the coil 14 via the seed layer 20. The present embodiment is characterized in that the seed layer 20 is left on the surface of the substrate, and that the resist pattern, which used for forming the lower magnetic pole 12 and the back gap section 15 formed on the lower magnetic pole layer 16, is formed in that state.

Namely, after forming the coil 14, the surface of the substrate including the coil 14 is coated with resist 24, then the resist 24 is patterned on the basis of planar patterns of the lower magnetic pole 12 and the back gap section 15 as shown in FIG. 1E. With this step, grooves 24a, in which the lower magnetic pole 12 and the back gap section 15 will be respectively formed and the seed layer 20 is exposed as inner bottom faces, are formed in the resist 24.

In FIG. 1F, after the resist 24 is patterned, the substrate is ion-milled so as to remove the seed layer 20 exposed in the grooves 24a. By removing the seed layer 20 exposed as the inner bottom faces of the grooves 24a, a surface of the lower magnetic pole layer 16, which is a lower layer, is exposed in the grooves 24a.

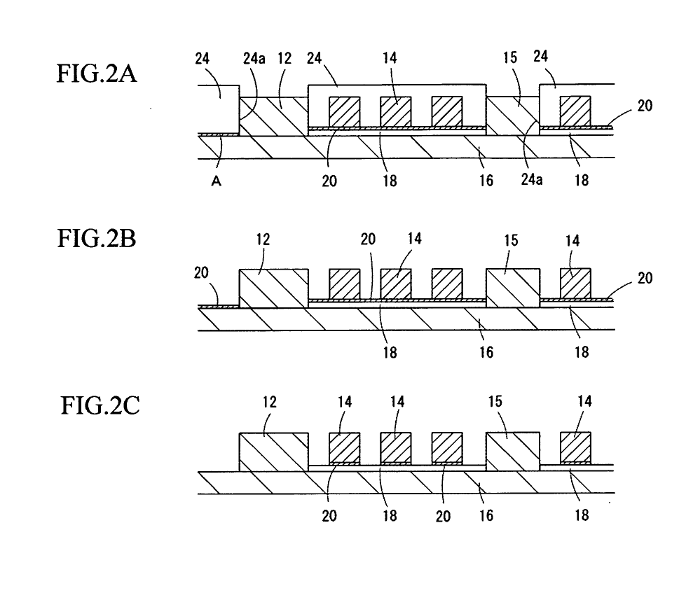

Further production steps will be explained with reference to FIGS. 2A-2C.

In FIG. 2A, the grooves 24a of the resist 24 are filled with a magnetic material by electrolytic plating with using the seed layer 20 as the electric power feeding layer. With this step, the lower magnetic pole 12 and the back gap section 15 are formed. The lower magnetic pole 12 and the back gap section 15 are made of a magnetic material including NiFe as well as the lower magnetic pole layer 16.

The lower magnetic pole layer 16 is an electric conductive layer, and the surface of the lower magnetic pole layer 16 is not entirely coated with the insulating layers 18. Therefore, the lower magnetic pole layer 16 and the seed layer 20 are partially directly electrically connected. Even if the seed layer 20 is partially removed by ion milling so as to form the lower magnetic pole 12 and the back gap section 15, the lower magnetic pole layer 16 and the seed layer 20 are partially directly electrically connected. In FIG. 1F, the lower magnetic pole layer 16 and the seed layer 20 are electrically connected in a part “A”.

When the lower magnetic pole 12 and the back gap section 15 are formed by electrolytic plating, the seed layer 20 is electrically connected to the lower magnetic pole layer 16, so that the lower magnetic pole layer 16 can be electrically connected to plating electrodes. Therefore, the lower magnetic pole 12 and the back gap section 15 can be formed on the lower magnetic pole layer 16 by electrolytic plating. With this step, the lower magnetic pole 12 and the back gap section 15 can be integrally formed with the lower magnetic pole layer 16 without providing a seed layer on the lower magnetic pole layer 16.

In an actual production process, many magnetic heads are formed in one wafer substrate. The magnetic heads are arranged like a matrix in the substrate. The lower magnetic pole layer 16, the coil 14, the lower magnetic pole 12, etc. are patterned in each unit area, in which one magnetic head is formed. When the lower magnetic pole layer 16 and the lower magnetic pole 12 are formed by electrolytic plating, the plating electrodes of a plating apparatus are electrically connected to each unit area.

In the present embodiment, the seed layer 20, which is formed on the substrate so as to form the coil 14, is left until forming the lower magnetic pole 12 and the back gap section 15 by plating, the seed layer 20 is electrically connected to the electrodes of the plating apparatus and the unit area, in which one magnetic head is formed. Namely, the seed layer 20 acts as a bus line for plating. In other words, the seed layer 20 may be left or the resist 24 may be patterned so as to electrically connect the seed layer 20 to the lower magnetic pole layer 16 of each unit area.

In FIG. 2B, the resist 24 is removed from the surface of the substrate. By removing the resist 24, the seed layer 20 is exposed in the surface of the substrate.

In the area in which the coil 14 is formed, a wire of the coil 14 is electrically conductive by the seed layer 20. Therefore, the substrate is ion-milled so as to remove the exposed seed layer 20.

In FIG. 2C, the seed layer 20, which has been exposed in the surface of the substrate, is removed, and the wire of the coil 14 is formed into an independent pattern.

With this step, the coil 14 is formed and electrically insulated form the lower magnetic pole layer 16 by the insulating layer 18, and the lower magnetic pole 12 and the back gap section 15 can be formed and integrated with the lower magnetic pole layer 16.

Note that, the magnetic head including the layered coils 14 may be produced by the steps of: applying an insulating material, e.g., alumina, on the surface of the substrate by sputtering; filling spaces in the coil 14, etc. with an insulating material so as to flatten the surface of the substrate; exposing the lower magnetic pole 12 and the back gap section 15 of the first layer; and forming the coil, the lower magnetic pole and the back gap section of the second layer.

The coil, the lower magnetic pole and the back gap section of the second layer can be formed as well as those of the first layer. Namely, they may be formed by the steps of: forming the seed layer on the surface of the substrate so as to form the recording coil; forming or patterning the coil; forming the resist pattern of the lower magnetic pole and the back gap section of the second layer without removing the seed layer; and removing the exposed seed layer by ion milling so as to expose the surfaces of the lower magnetic pole of the first layer and the back gap section of the first layer. When the lower magnetic pole and the back gap section of the second layer are formed, the seed layer is left so as to electrically connect to the lower magnetic pole 12 and the back gap section 15 of the first layer.

Further, the lower magnetic pole and the back gap section of the second layer are respectively formed on the lower magnetic pole 12 and the back gap section 15 of the first layer by electrolytic plating with using the seed layer as the electric power feeding layer. Then, the resist pattern is removed, and the exposed parts of the seed layer are removed so that the coil of the second layer, which is an independent pattern, can be formed.

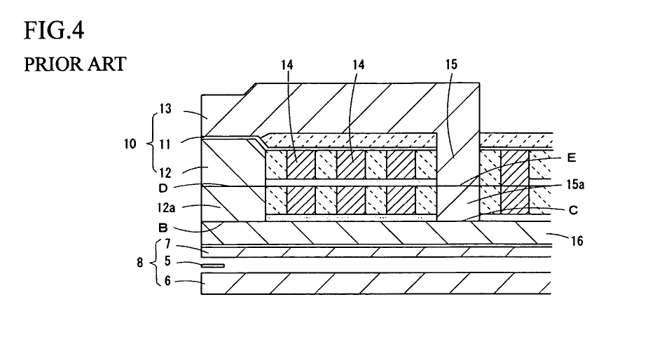

In the method of the present embodiment, the lower magnetic pole 12 and the back gap section 15 are directly connected to the lower magnetic pole layer 16 at connecting parts “B” and “C” (see FIG. 4) without providing a different metal layers, e.g., seed layer. Therefore, in comparison with the conventional magnetic head, magnetic loss in a magnetic path of the write-head can be reduced, and characteristics of the write-head can be improved.

The lower magnetic poles 12 of the first and the second layers are integrated at a connecting part “D”, and the back gap sections 15 of the first and the second layers are integrated at a connecting part “E” (see FIG. 4). Therefore, magnetic loss of the write-head 10 can be reduced.

As shown in FIGS. 2B and 2C, the dusts of the seed layer 20 is scattered and stick onto the side faces of the coil 14 when the seed layer 20 between the wire of the coil 14 is removed by ion milling. In the conventional method, the dusts 20a of the seed layer 20, which is used for forming the coil 14, and the dusts 22a of the seed layer 22, which is used for forming the lower magnetic pole 12 and the back gap section 15, stick. On the other hand, in the present embodiment, only the dusts of the seed layer 20 stick. Therefore, unlike the conventional method, the coil 14 is not widened. Further, the seed layer 20 and the coil 14 is made of the same material, e.g., copper. Therefore, electrical characteristics of the coil 14 are not badly influenced.

Since the dusts sticking onto the coil 14 can be reduced, separations between the coil wire can be shorter so that the coil 14 can be smaller. Therefore, the magnetic head can be downsized. Further, inductance of the small coil 14 can be reduced, so that high-frequency properties or writing speed of the magnetic head can be improved.

In the method of the present embodiment, no seed layers for forming the lower magnetic pole 12 and the back gap section 15 by electrolytic plating are provided. By omitting the step of forming the seed layers, the production process of the write-head 10, in which the coil 14, the lower magnetic pole 12 and the back gap section 15 are formed by electrolytic plating, can be simplified.

Note that, the present invention is not limited to a magnetic head for horizontal magnetic recording. The present invention may be applied to a magnetic head for vertical magnetic recording. Types of the magnetic head are not limited to the foregoing description.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a magnetic head, which includes a recording coil, a lower magnetic pole and a back gap section formed by electrolytic plating,
comprising the steps of:
forming a seed layer for plating on a lower layer so as to form the recording coil;
forming the recording coil on the seed layer, by electrolytic plating, with using the seed layer as an electric power feeding layer;
patterning resist on the seed layer so as to form the lower magnetic pole and the back gap section;
removing exposed parts of the seed layer with using the resist as a mask;
exposing parts of the lower layer, in which the lower magnetic pole and the back gap section will be formed; and
forming the lower magnetic pole and the back gap section in the lower layer, by electrolytic plating, with using the seed layer as the electric power feeding layer.

2. The method according to claim 1,
wherein the resist is applied to a part of the seed layer, which coats the lower layer and which can be electrically connected to electrodes of a plating apparatus, in said patterning step.

3. The method according to claim 1,
further comprising the steps of:
removing the resist after forming the lower magnetic pole and the back gap section; and
removing a useless part of the seed layer by ion milling.

4. The method according to claim 1,
wherein the lower layer is a lower magnetic pole layer of a write-head, and
the recording coil, the lower magnetic pole and the back gap section are formed on the lower magnetic pole layer.

5. A magnetic head,
comprising:
a write-head including a lower magnetic pole layer, which is formed by electrolytic plating, and a lower magnetic pole and a back gap section, which are formed on the lower magnetic pole layer,
wherein the lower magnetic pole layer and the lower magnetic pole are integrated, and the lower magnetic pole layer and the back gap section are integrated without forming seed layers for plating between the lower magnetic pole layer and the lower magnetic pole and between the lower magnetic pole layer and the back gap section.

6. A magnetic head,
comprising:
a write-head including a plurality of lower magnetic poles and a plurality of back gap sections, which are formed by electrolytic plating and layered in a thickness direction,
wherein the lower magnetic poles are integrated, and the back gap sections are integrated without forming seed layers for plating between the lower magnetic poles and between the back gap sections.
